(19) United States
(12) Patent Application Publication
(10) Pub. No.: US 2020/0016532 A1
(43) Pub. Date: Jan. 16, 2020

(54) METHOD OF REDUCING CORROSION OF A HEAT EXCHANGER OF AN INCINERATOR COMPRISING SAID HEAT EXCHANGER

(71) Applicant: MINPLUS B.V., Apeldoorn (NL)

(72) Inventor: Joseph Jan Peter BIERMANN, Apeldoorn (NL)

(73) Assignee: MINPLUS B.V., Apeldoorn (NL)

(21) Appl. No.: 16/495,737

(22) PCT Filed: Mar. 26, 2018
(86) PCT No.: PCT/NL2018/050184

§ 371 Date: Sep. 19, 2019

(30) Foreign Application Priority Data
Mar. 29, 2017 (NL) 2018595
Dec. 8, 2017 (NL) 2020048

(51) Int. Cl. B01D 53/83; B01D 53/38; F23J 15/00

(52) U.S. Cl. CPC B01D 53/83; B01D 53/38; B01D 2258/0283; B01D 2251/404; B01D 2251/606; F23J 15/003

(57) ABSTRACT

A method of reducing corrosion of a heat exchanger of an incinerator, said method comprising the steps of—introducing oxygen-comprising gas and a particulate fuel into a combustion chamber,—introducing an additive material comprising i) clay and ii) calcium carbonate into the incinerator,—recuperating heat from the flue gas using a heat exchanger. For protecting the heat exchanger, the additive material is a powdery material that is introduced into the flue gas upstream of the heat exchanger, a powder particle of said powdery additive material comprising granules, each granule comprising a mixture of clay and calcium carbonate, at least 10% by weight relative to the calcium carbonate being calcium carbonate in a form that when characterized by means of Thermogravimetric Analysis under a nitrogen atmosphere with a rate of increase in temperature of 10 JC per minute has decomposed completely when a temperature of 875° C. has been reached.

A method of reducing corrosion of a heat exchanger of an incinerator comprising said heat exchanger

The present invention relates to a method of reducing corrosion of a heat exchanger of an incinerator, said incinerator comprising
a chamber for incinerating fuel in the presence of oxygen-comprising gas,
a heat exchanger, and
a flue gas channel for passing flue gas emanating from the chamber along the heat exchanger for absorbing heat from the flue gas;
   the method comprising the steps of

introducing oxygen-comprising gas and a particulate fuel into the chamber to incinerate said particulate fuel resulting in a flue gas,

introducing an additive material comprising i) clay and ii) calcium carbonate into the incinerator,

recuperating heat from the flue gas using the heat exchanger.

It is generally known to incinerate a fuel and recuperate heat generated, for example to turn water into steam, which may then for example be used to produce electricity. It is also known to cool the flue gas down for further treatment thereof, such as collecting of particulates or the removal of unwanted compounds prior to venting the flue gas into the atmosphere. A problem is that the heat exchanger or other internals through which the flue gas passes are subject to corrosion. Corrosion adversely affects the frequency and/or duration of maintenance of the incinerator, resulting in increased cost. To slow down the rate of corrosion, WO2013093097 discloses a method according to the preamble wherein a mineral additive blend comprising clay and a functional mineral (calcium carbonate) is introduced into a furnace, a fuel is introduced into the furnace and the two are heated with the fuel being incinerated. The amount of additive material that has to be introduced is relatively high, adding to the cost of the method. Also, as a consequence, a further disadvantage of the known method is that the amount of ash produced is significantly increased.

Reduction of the rate of corrosion by means of adding alkaline containing additives to the flue gas is not straightforward. Most alkaline additives are capable of reducing the total amount of corrosive compounds—anions—in the flue gas, but this typically results in an increased rate of corrosion. This is caused by a preference of these alkaline additives to remove sulphur compounds from the flue gas, which reduces the formation of protective deposits of sulphate containing material on the boiler internals, leaving these internals more vulnerable for corrosion by other flue gas constituents such as chlorides, which are harder to capture from the flue gas by such additives. This effect of alkaline additives causing increased corrosion when applied in flue gases containing both sulphur and chlorine compounds is described in “High-Temperature Chlorine Corrosion during Co-Utilisation of Coal with Biomass or Waste, Xiaoyang Gaus-Liu, Dissertation University of Stuttgart, ISBN 978-3-86727-568-2”. To further extend the sometimes unexpected phenomena related to boiler corrosion, it is known that the addition of sulphur containing compounds—which themselves are corrosive—to the flue gas can be applied to reduce corrosion of high temperature equipment. The sulphur containing compounds shield the boiler internals from more rapid corrosion by for instance chlorine compounds from the flue gas. This effect is described in EP1271053 and WO2006/124772. In summary, it is recognized in the art that high-temperature corrosion protection of heat exchangers in incinerators is problematic with alkaline additives.

The object of the present invention is to reduce corrosion of a heat exchanger of an incinerator.

To this end, a method according to the preamble is characterized in that the additive material is a powdery material that is introduced into the flue gas upstream of the heat exchanger, a powder particle of said powdery additive material comprising granules, each granule comprising a mixture of clay and calcium carbonate, at least 10% by weight relative to the calcium carbonate being calcium carbonate in a form that when characterized by means of Thermogravimetric Analysis under a nitrogen atmosphere with a rate of increase in temperature of 10° C. per minute has decomposed completely when a temperature of 875° C. has been reached.

Thus the method according to the present invention allows for reduced downtime for heat exchanger maintenance and/or heat exchange at a higher temperature at a relatively low rate of use of additive material. With the method according to the invention, high-temperature corrosion (wall temperature of the heat exchanger of 500° C. or higher) is reduced.

While it is known in the art to use calcium carbonate as an additive material, it has been found that not all calcium carbonate is equal. Using Thermogravimetric Analysis (TGA) it is possible to select a calcium carbonate-comprising additive material suitable for the reduction of high-temperature corrosion.

Thermogravimetric Analysis (TGA) measures the mass reduction upon heating the sample at a specified rate in a specified atmosphere. The measured mass reduction of the additive material then can be attributed to the dissociation of CaCO₃ and its simultaneous release of CO₂. For the claimed invention, the method described by A. W. Coats and J. P. Redfern, in Thermogravimetric analysis; A review, Analyst, 1963, 88, 906-924, DOI: 10.1039/AN9638800906 is the standard method.

Background: Since the molar weight of CaCO₃ and that of CaO differ, this difference in mass due to decomposition under release of CO₂ can be measured. In practice, it may be verified that the measured weight loss is actually due to the release of gaseous CO₂. To that end, the gas leaving the exit of the TGA measurement device is characterized by means of any suitable method, such as mass spectrometry.

To briefly describe the method of Coats et al, TGA measurements are carried out under a nitrogen atmosphere and at a heating rate of 10° C. per minute from ambient temperature up to typically 1100° C. The weight of the sample is expressed as percent of calcium carbonate, where 100% represents non-converted calcium carbonate. Since the (rounded) molar weight of CaCO₃ is 100 g/mol, and that of the CO₂ released upon heating the carbonate is 44 g/mol, the remaining mass fraction after decomposition is 56%.

In the art it is known to use dolomite or limestone as additive materials. It has been found that these arrive at full decomposition only at higher temperatures. These materials furthermore were found to be not capable of reducing corrosion in boilers. The example section goes into more detail.

In the present application the term particulate fuel means that the fuel is solid at a temperature of 30° C. The chamber into which the fuel is introduced is for example a fluidized bed or the chamber of a grate incinerator. The size of the fuel particles may be relatively small (e.g. in the order of millimeters or smaller) or relatively large (e.g. in the order of centimeters or larger). The particulate fuel is for example biomass, refuse from industrial processes or households or mixtures thereof.

The term powdery material indicates material having a particle size of less than 100 μm. These particles have a granular nature, i.e. a particle typically comprises a multitude of even smaller particles.

In general, the additive material will be introduced in the flue gas where the flue gas has a temperature of at least 850° C. and less than 1150° C. In case of an incineration process involving flames, it is preferred that the additive material is injected downstream of the flames.

The residence time of the additive in the flue gas prior to leaving the heat exchanger is typically at least 1 second, preferably at least 3 seconds, and more preferably at least 5 seconds. Thus at least part of the heat exchanger is protected. Preferably, the residence time is such that the residence time of the additive in the flue gas before entering the heat exchanger is at least 1 second, preferably at least 3 seconds, and more preferably at least 5 seconds.

Typically, the flue gas is flue gas containing non-gaseous material. Such non-gaseous material in the flue gas typically comprises solid or at least partially molten particles originating from the fuel. Typically, the concentration of non-gaseous material is more than 0.02% by wt. relative to the weight of the flue gas.

The method according to the invention is very suitable for the incineration of particulate waste material. Thus the particulate fuel will typically consist for more than 50%, preferably more than 75%, and even more preferably more than 90% of such material (including mixtures of household and industrial waste materials).

The oxygen-comprising gas is typically air.

Typically the water content of the additive material will be less than 2% wt./wt. of the additive material.

According to a favourable embodiment, at least 40% by weight and more preferably at least 70% relative to the calcium carbonate is calcium carbonate in a form that when characterized by means of Thermogravimetric Analysis under a nitrogen atmosphere with a rate of increase in temperature of 10° C. per minute has decomposed completely when a temperature of 875° C. has been reached.

Thus less additive is needed and a reduced amount of solids has to be captured before release of the flue gas into the atmosphere as may be desired or required.

According to a favourable embodiment, the additive material is introduced in the flue gas where the flue gas has a temperature in a range from 875° C. to 1050° C., and preferably in a range from 900° C. to 1000° C.

This has been found to work well. A higher temperature typically results in a higher rate of corrosion. However, with the method according to the invention this process can be suppressed. This allows for a longer maintenance interval between planned operational stops, which are typically related to inspections, maintenance and/or repair of boiler parts in view of depositions and corrosion. In addition or alternatively, in the heat exchanger heat can be recuperated at a higher temperature and/or a smaller and hence cheaper heat exchanger may be used.

According to a favourable embodiment, the powdery additive material is introduced with a rate of at least 0.005% by mass relative to the flow of flue gas, preferably with a rate of at least 0.02% by mass and most preferably at least 0.04% by mass.

The flow rates are expressed in kg/s. The amount added is typically less than 0.4% by mass, and preferably less than 0.2% by mass to avoid an unnecessary increase in effort to remove particulates from the flue gas and/or the disposal thereof after removal using a technique such as cyclone separation, filtration or washing.

According to a favourable embodiment, the incinerator is part of a plant, said plant further comprising a unit for the thermal conversion of paper waste material comprising kaolin, wherein the kaolin is thermally treated in a fluidized bed having a freeboard in the presence of oxygenous gas,

wherein the fluidized bed is operated at a temperature between 720 and 850° C. and the temperature of the freeboard is 850° C. or lower to result in the powdery additive material, which is introduced into the flue gas of the incinerator.

The method of preparing this powdery additive material is disclosed in detail in WO9606057, which is incorporated by reference.

According to a favourable embodiment, the weight/weight ratio of convertible calcium carbonate to the clay is in the range of 1 to 10, preferably 1 to 5 and more preferably 1 to 3.

Thus the amount of additive material can be kept relatively low while the rate of corrosion is reduced.

According to a favourable embodiment, the powdery material has a water content of less than 0.9% wt./wt. %, preferably less than 0.5% wt./wt.

This helps to quickly disperse the powdery material into the flue gas.

According to a favourable embodiment, additive-comprising material is collected from the flue gas downstream of the heat exchanger,

and part of said particulate material is re-introduced into the flue gas upstream of the heat exchanger.

Thus a saving on the amount of additive material can be achieved, in particular in those cases where the residence time before the heat exchanger is short.

The invention will now be illustrated with reference to the example section below, and with reference to the drawing wherein

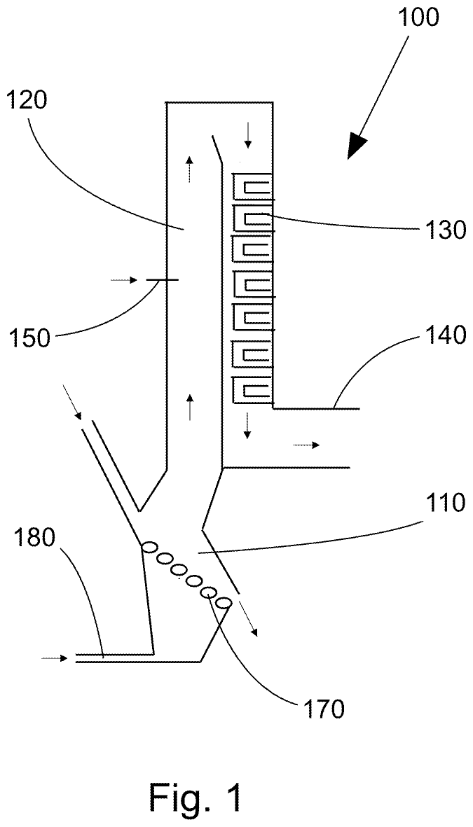

FIG. 1 shows a schematic view of an incinerator; and

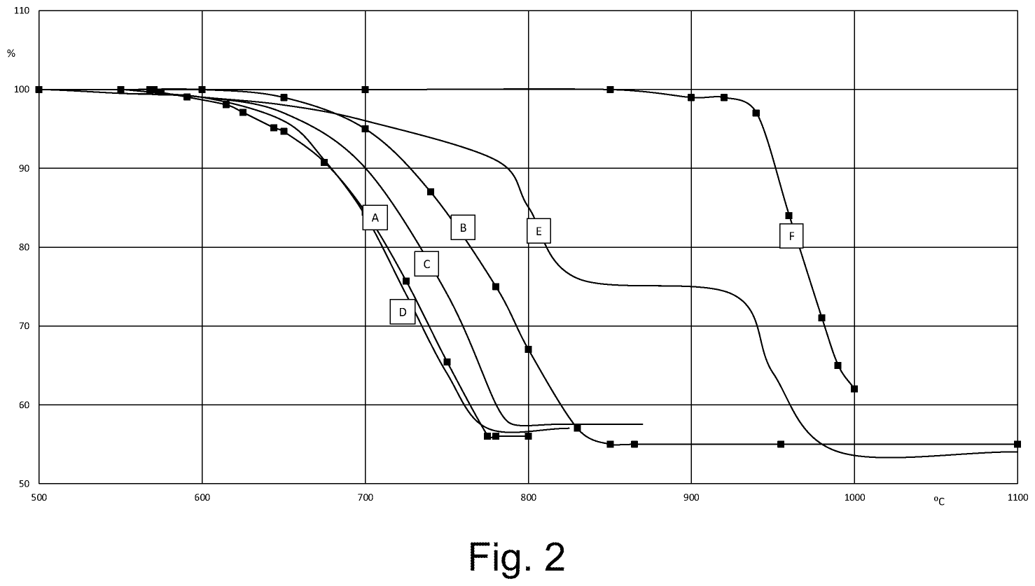

FIG. 2 shows a Thermogravimetric Analysis (TGA) graph for various calcium carbonate-comprising materials.

FIG. 1 shows a plant comprising an incinerator 100 comprising a combustion chamber 110, a flue gas channel 120, a heat exchanger 130 and an exhaust pipe 140.

A mixture of household and industry derived waste materials was fed from a fuel storage via a hopper on a grate 170. Air is introduced into the combustion chamber 110 via an air supply conduit 180.

Additive material is introduced into the flue gas channel 120 via lances 150.

Downstream of the heat exchanger, the additive material is separated from the cooled down flue gas from the heat exchanger 130 using a conventional filter system before the cleaned flue gas is vented to the atmosphere via the exhaust pipe 140.

### EXPERIMENTAL SECTION

1. Characterization of Additive Material

The following materials were used for incineration experiments, and characterised as discussed below.

Powder Size

Laser diffraction was used to measure particle size in the range of 0.1-600 μm. Typically, a solid-state, diode laser is focused by an automatic alignment system through the measurement cell. Light is scattered by sample particles to a multi-element detector system including high-angle and backscatter detectors, for a full angular light intensity distribution. In a typical test, 10 mg of a sample was added to the liquid dispersing medium. The recommended dispersing medium for the samples is isopropyl alcohol. 95% by weight of the particles of the samples A to F described below had a size of less than 100 μm.

Additive material suitable for use in the present invention

—A—Calcium carbonate-containing material produced from deinking paper sludge prepared in accordance with WO0009256.

The material's composition was determined by means of X-ray fluorescence. The material contained 30 mass % of calcium carbonate; 25 mass % of calcium oxide; and 36% of silica-alumina clay in the form of meta-kaolin.

Reference Materials:

—B—Laboratory grade calcium carbonate (laboratory grade calcium carbonate, Perkin Elmer Corporation, Waltham, Mass., USA)

—C—Ground limestone (mercury sorbent, sample obtained from the Chemical Lime Company in St. Genevieve, Mo., USA)

—D—Ground limestone (sample obtained from the Mercury Research Center at 19 Gulf Utility, Pensacola, Fla., USA)

—E—Ground dolomite stone (sample obtained from the USA National Institute of Standards and Technology (NIST) denoted as standard reference material (SRM) 88b))

—F—Ground limestone (sample obtained from the USA National Institute of Standards and Technology (NIST) denoted as standard reference material (SRM) 1d. SRM 1d is composed of argillaceous limestone)

Material Decomposition

TGA measurements were carried out in a nitrogen atmosphere and at a heating rate of 10° C. per minute using a Setaram Labsys EVO TGA apparatus (Setaram Company, Caluire, France).

As can be seen in FIG. 2, where the curves A-F correspond to the calcium carbonate-comprising materials listed above, the decomposition of calcium carbonate occurs at different temperatures. For curve E, it is the second steep downward slope at about 950° C. that relates to the decomposition of calcium carbonate, the first steep slope at about 800° C. relating to the decomposition of magnesium carbonate.

EDX Measurements

Individual particles of the additive material (A) produced in accordance with WO0009256 contain both clay and calcium compounds as can be observed from Energy Dispersive X-ray spectroscopy (EDX) applied in conjunction with Electron Microscopy (EM), both methods are considered known to someone skilled in the art. EDX measurements on even the smallest particulates visible in the EM, typically having dimensions of a few micrometers, show that in each particulate both calcium- and silica/alumina species are present. The calcium represents the calcium and calcium carbonates present in the additive material, whereas the silica/alumina species represent the clay fraction present in the additive material.

2. Incineration Experiment

Experiments were performed using the incinerator 100 substantially as shown in FIG. 1.

The incinerator processed an averaged amount of fuel of 4.2 kg/s consisting of a mixture of household and industrial derived waste materials. The incineration resulted in an averaged flue gas flow of 30.5 kg/s. The additive applied in this example was produced from a mixture of paper residue and composted sewage sludge in a weight ratio of 85% to 15%, using the method descried in WO9606057. The additive is injected into the flue gas of the incinerator leaving the incineration chamber at a height of 19 meters measured from the lowest point of the incineration grate. During the experiment it was observed that no flames reached this height for more than 90% of the duration of the experiment. The first heat exchanger internal—boiler tube—protruding into the flue gas flow, is located at more than 30 meters downstream of the additive injection location. The temperature of the flue gas at the location of the additive injection varied with the particulate fuel and the energy production in the incinerator, being between 950 and 1050° C. Typically 0.02 kg/s of additive was injected into the flue gas by means of pneumatic injection through four steel injection lances (right-pointing arrow in FIG. 1) of 32 mm internal diameter, resulting in a ratio of additive to flue gas of 0.06-0.07% wt./wt. The averaged velocity of the injection air was 15 m/s. Injection of the additive was continued for nine months in a full calendar year of operating the incinerator. After this one year period, the incineration was stopped for regular maintenance during which stop the boiler tubes were inspected for corrosion. The decay of the thickness of the walls of the heat exchanger boiler tubes was used as indication of corrosion, because the thickness of the walls of these tubes is what determines the longevity of these tubes for their duty in the heat exchanger, as well as the risk of boiler tube failure during operation. Boiler tube wall thickness measurements were carried out by means of ultrasonic measurement on a multitude of individual boiler tubes, resulting in several hundreds of wall thickness measurements on tubes located in various—documented—locations of the incinerator heat exchanging section. Comparison of these wall thickness measurements to those carried out in previous years at the same locations, was carried out by expressing the measured decay of wall thickness on a per million ton of processed fuel basis (mm decay per million tons), thus correcting for non-equal intervals between wall thickness measurements in different years. Comparison of wall thickness decay of boiler tubes in the year in which the additive was applied for a period of nine months to the observed wall thickness decay of boiler tubes in the two preceding years indicated that at hot flue gas sections with boiler tube wall temperatures of 600° C., the decay of wall thickness was reduced by over 60%. The decay in slightly cooler sections with boiler tube wall temperatures of 500° C. was reduced by over 40%. Both results demonstrate a significant reduction in high-temperature corrosion when applying the additive. Application of the additive in consecutive years with additive injection applied during the entire year resulted in a further decrease of high-temperature corrosion, as witnessed from an almost unmeasurable decay of wall thickness of boiler tubes.

It was further observed that deposits of partially molten materials originating from the fuel on the heat exchanger boiler tubes had become more brittle displaying a reduced degree of melting of these deposits.

The above data suggest that introducing the additive as specified in the appended main claim is also suitable for an equivalent method for the gasification of a material, and in particular a method of operating a gasifier, said gasifier comprising
a chamber for gasifying fuel in the presence of oxygen-comprising gas by incomplete conversion of the fuel,
a heat exchanger, and
a flue gas channel for passing flue gas emanating from the chamber along the heat exchanger for absorbing heat from the flue gas;

the method comprising the steps of
introducing oxygen-comprising gas and a particulate fuel into the chamber for gasifying the particular fuel resulting in gas containing at least 5% by vol. of CO and typically more than 10% by vol.,
introducing an additive material comprising i) clay and ii) calcium carbonate into the gasifier,
recuperating heat from the flue gas using the heat exchanger;

characterized in that the additive material is a powdery material that is introduced into the flue gas upstream of the heat exchanger, a powder particle of said powdery additive material comprising granules, each granule comprising a mixture of clay and calcium carbonate, at least 10% by weight relative to the calcium carbonate being calcium carbonate in a form that when characterized by means of Thermogravimetric Analysis under a nitrogen atmosphere with a rate of increase in temperature of 10° C. per minute has decomposed completely when a temperature of 875° C. has been reached.

Preferably, the additive material will be added to the flue gas at a flue gas temperature of less than 1200° C.

Preferred embodiments correspond to the dependent claims of the method of incinerating listed below.

1. A method of reducing corrosion of a heat exchanger (130) of an incinerator (100), said incinerator (100) comprising
a chamber (110) for incinerating fuel in the presence of oxygen-comprising gas,
a heat exchanger (130), and
a flue gas channel (120) for passing flue gas emanating from the chamber (110) along the heat exchanger (130) for absorbing heat from the flue gas;
the method comprising the steps of
introducing oxygen-comprising gas and a particulate fuel into the chamber (110) to incinerate said particulate fuel resulting in a flue gas,
introducing an additive material comprising i) clay and ii) calcium carbonate into the incinerator (100),
recuperating heat from the flue gas using the heat exchanger (130);
wherein the additive material is a powdery material that is introduced into the flue gas upstream of the heat exchanger (130), a powder particle of said powdery additive material comprising granules, each granule comprising a mixture of clay and calcium carbonate, at least 10% by weight relative to the calcium carbonate being calcium carbonate in a form that when characterized by means of Thermogravimetric Analysis under a nitrogen atmosphere with a rate of increase in temperature of 10° C. per minute has decomposed completely when a temperature of 875° C. has been reached.

2. The method according to claim 1, wherein at least 40% by weight and more preferably at least 70% relative to the calcium carbonate is calcium carbonate in a form that when characterized by means of Thermogravimetric Analysis under a nitrogen atmosphere with a rate of increase in temperature of 10° C. per minute has decomposed completely when a temperature of 875° C. has been reached.

3. The method according to claim 1 or 2, wherein the additive material is introduced in the flue gas where the flue gas has a temperature in a range from 875° C. to 1050° C., and preferably in a range from 900° C. to 1000° C.

4. The method according to any of the preceding claims, wherein the powdery additive material is introduced with a rate of at least 0.005% by mass relative to the flow of flue gas, preferably with a rate of at least 0.02% by mass and most preferably at least 0.04% by mass.

5. The method according to any of the preceding claims, wherein the incinerator (100) is part of a plant, said plant further comprising a unit for the thermal conversion of paper waste material comprising kaolin, wherein the kaolin is thermally treated in a fluidized bed having a freeboard in the presence of oxygenous gas, wherein the fluidized bed is operated at a temperature between 720 and 850° C. and the temperature of the freeboard is 850° C. or lower to result in the powdery additive material, which is introduced into the flue gas of the incinerator (100).

6. The method according to any of the preceding claims, wherein the weight/weight ratio of convertible calcium carbonate to the clay is in the range of 1 to 10, preferably 1 to 5 and more preferably 1 to 3.

7. The method according to any of the preceding claims, wherein the powdery material has a water content of less than 0.9% wt./wt. %, preferably less than 0.5% wt./wt.

8. The method according to any of the preceding claims, wherein additive-comprising material is collected from the flue gas downstream of the heat exchanger (130),
and part of said particulate material is re-introduced into the flue gas upstream of the heat exchanger (130).
